(19) United States
(12) Patent Application Publication
(10) Pub. No.: US 2010/0237737 A1
(43) Pub. Date: Sep. 23, 2010

(54) OPTIMIZED BI-DIRECTIONAL ELECTROSTATIC ACTUATORS

(76) Inventors: Siyuan He, Toronto (CA); Ridha BenMrad, Toronto (CA)

Correspondence Address: NASSER ASHGRIZ, 7805 Bayview Ave., # 1510, Thornhill, ON, L3T 7N1, CA

(21) Appl. No.: 11/993,332

(22) PCT Filed: Jul. 7, 2006
(86) PCT No.: PCT/CA06/01143

§ 371 Date: May 10, 2010

Related U.S. Application Data
(60) Provisional application No. 60/696,812, filed on Jul. 7, 2005.

(51) Int. Cl. H02N 1/08; G06F 17/17

(52) U.S. Cl. 310/300; 703/2

(57) ABSTRACT

An electrostatic actuator comprising: first and second comb arrays of electrodes arranged on a base, the electrodes of the first and second comb arrays being interleaved; a third comb array of electrodes spring mounted over the first and second comb arrays, the electrodes of the third comb array being aligned with the electrodes of the second comb array; and, means for applying a first voltage to the third comb array and a second voltage to the first and second comb arrays to generate an attractive force acting on the third comb array to move the third comb array toward the second comb array; wherein: the electrodes of the third comb array each have a thickness tj and a width a such that a≧tf, the electrodes of the second comb array each have a width b such that a≦b≦10a; the electrodes of the first and second comb arrays are separated by a distance d such that 0.5Z><d≦4b; and, the electrodes of the first comb array each have a width c such that 0.5b<c≦5b. Preferably, the means is adapted for applying the first voltage to the second and third comb arrays and the second voltage to the first comb array to generate a repulsive force acting on the third comb array to move the third comb array away from the second comb array. A method for modeling the design of a bi-directional electrostatic actuator is also provided.

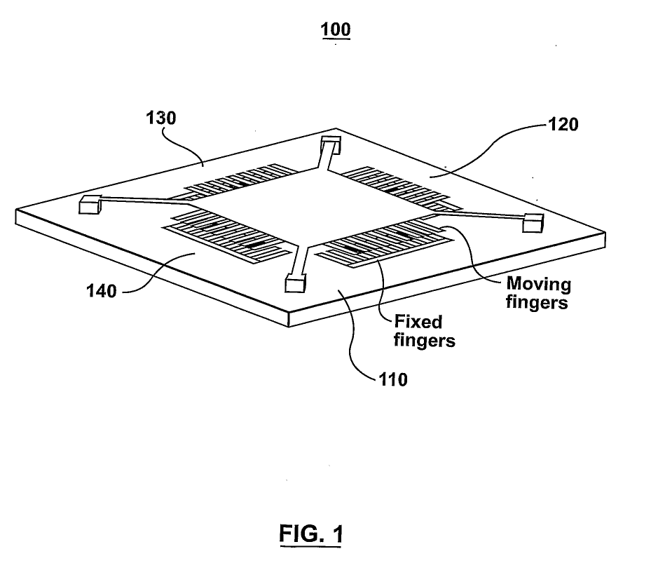

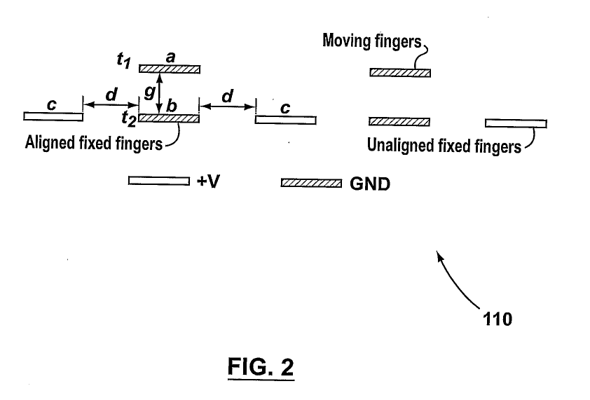

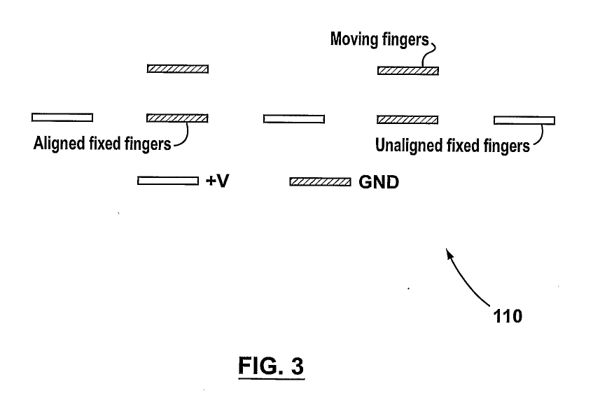

### FIELD OF THE INVENTION

The invention relates to the field of electrostatic actuators, and more particularly, to bi-directional electrostatic actuators to be used in RF MEMS devices such as tunable capacitors and optical MEMS devices such as torsion micromirrors and translation micromirrors.

### BACKGROUND OF THE INVENTION

Microelectromechanical systems (MEMS) are the integration of mechanical elements and electronics on the same chip using microfabrication technology similar to the IC process to realize high performance and low cost functional devices such as micro sensors and micro actuators.

MEMS is becoming an enabling technology in many fields as it enables the construction of devices or systems characterized by high performance, small size, small weight and low cost. Typical MEMS applications include: inertial measurement units such as micro accelerometers and micro gyroscopes; optical MEMS such as digital light processing (DLP) systems, micro optical switches and micromirrors for adaptive optics; and, RF MEMS devices such as micro RF switches, micro oscillators and micro varactors.

Micro actuators are important building blocks in constructing MEMS devices. There are four main actuation techniques used in MEMS, i.e., electrostatic, thermal, magnetic and piezoelectric. Among them the electrostatic actuation is the most used one because of its outstanding advantages such as low power consumption, simple structure, quick response, and especially high compatibility with IC fabrication technology. Micro electrostatic actuators can be categorized into two types, i.e., lateral (in-plane) actuators which move in the plane parallel to the substrate, and out-of-plane actuators which move in the plane perpendicular to the substrate. For lateral actuation or in-plane movement, combdrive types are preferred. The parallel-plate configuration is most suitable for vertical actuation or out-of-plane movement.

A conventional (out-of-plane) electrostatic actuator uses attractive electrostatic force and consists of two parallel plate electrodes: a fixed electrode and a moving electrode. The moving electrode is pulled down toward the fixed electrode by an attractive electrostatic force when a potential is applied between the two electrodes and it moves back to its original position due to a restoring force from supporting flexures when the voltage is removed.

The application of conventional parallel plate attractive electrostatic actuators is limited by the “pull-in” effect when the displacement of the moving electrode exceeds ⅓ of the initial gap distance, the linear restoring force from the flexures cannot counteract the rapidly increasing nonlinear electrostatic attractive force between the fixed and moving electrodes, and as such the moving electrode sticks to the fixed electrode. A detailed explanation of the “pull-in” effect in conventional parallel-plate micro electrostatic actuators can be found in U.S. Pat. No. 5,753,911. Because of the “pull-in” effect the stroke of a conventional parallel-plate actuator is limited to less than one third of the initial gap distance between the fixed and moving electrodes.

An electrostatic actuator utilizing both attractive and repulsive forces can provide bi-directional movement of the electrodes. The total stroke of such a bi-directional electrostatic actuator includes two parts, i.e., the displacement of the moving electrode in the direction toward the fixed electrode and that in the direction away from the fixed electrode. Therefore the stroke is not limited by the initial gap distance. Hence, a large stroke can be achieved by a bi-directional electrostatic actuator. Such an electrostatic actuator is described in U.S. patent application Ser. No. 11/249,628, which is incorporated herein by reference.

In developing bi-directional electrostatic actuators, a problem facing designers is how to choose structural parameters of the actuator in order to satisfy the requirements posed by different applications. Conventional parallel-plate type actuators have well established theoretical models which can be used in designing and optimization. However, the bi-directional electrostatic actuator described in U.S. Provisional patent application Ser. No. 11/249,628 has a principle of operation which is completely different from the conventional parallel-type design and hence existing models cannot be used in designing and optimizing such a bi-directional electrostatic actuator. In addition, the design of such a bi-directional electrostatic actuator involves analysis of 3D electric fields having complex boundary conditions. As such, traditional methods cannot be applied to the design of such bi-directional electrostatic actuators. Hence it would be highly desirable to have an effective method to model the force and displacement of such bi-directional actuators in order to optimize their repulsive force and stroke for different applications.

A need therefore exists for an optimized bi-directional electrostatic actuator. Consequently, it is an object of the present invention to obviate or mitigate at least some of the above mentioned disadvantages.

### SUMMARY OF THE INVENTION

An electrostatic actuator having (a) a base containing a plurality of electrodes; (b) a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and (c) a means for applying voltage to the electrostatic actuator, said means being operable to generate one, or both at different intervals, of: a repulsive electrostatic force by applying a voltage of V1 to the electrodes on the movable element, V1 to the aligned electrodes on the base and V2 to the non-aligned electrodes on the base; or an attractive electrostatic force by applying a voltage of V1 to the electrodes on the moveable element, and V2 to the aligned and non-aligned electrodes on the base; characterized in that the electrodes of the moveable element each have a thickness t₁ and a width a such that a≧t₁; and the width of the corresponding aligned electrode(s), b, is preferably not smaller than the width of the electrodes of the moveable element, a such that a≦b≦10a.

An electrostatic actuator characterized in that it includes: at least two electrostatic actuator elements, each electrostatic actuator element having: a base containing a plurality of electrodes; a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and a means for applying voltage to the electrostatic actuator, said means being operable to generate one, or both at different intervals, of: a repulsive electrostatic force by applying a voltage of V1 to the electrodes on the movable element, V1 to the aligned electrodes on the base and V2 to the non-aligned electrodes on the base; or an attractive electrostatic force by applying a voltage of V1 to the electrodes on the moveable element, and V2 to the aligned and non-aligned electrodes on the base; and wherein the moveable element of the at least two electrostatic actuator elements is formed on a common body.

A method of modeling a design for an electrostatic actuator (a) a base containing a plurality of electrodes; (b) a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and (c) a means for applying voltage to the electrostatic actuator, said means being operable to generate one, or both at different intervals, of: a repulsive electrostatic force by applying a voltage of V1 to the electrodes on the movable element, V1 to the aligned electrodes on the base and V2 to the non-aligned electrodes on the base; or an attractive electrostatic force by applying a voltage of V1 to the electrodes on the moveable element, and V2 to the aligned and non-aligned electrodes on the base; characterized by combining a numerical simulation and a least-square approximation to obtain the force and displacement of the moveable element.

According to one aspect of the invention, there is provided an electrostatic actuator comprising: first and second comb arrays of electrodes arranged on a base, the electrodes of the first and second comb arrays being interleaved; a third comb array of electrodes spring mounted over the first and second comb arrays, the electrodes of the third comb array being aligned with the electrodes of the second comb array; and, means for applying a first voltage to the third comb array and a second voltage to the first and second comb arrays to generate an attractive force acting on the third comb array to move the third comb array toward the second comb array; wherein: the electrodes of the third comb array each have a thickness t₁ and a width a such that a≧t₁; the electrodes of the second comb array each have a width b such that a≦b≦10a, the electrodes of the first and second comb arrays are separated by a distance d such that 0.5b≦d≦4b; and, the electrodes of the first comb array each have a width c such that 0.5b≦c≦5b. Preferably, the means is adapted for applying the first voltage to the second and third comb arrays and the second voltage to the first comb array to generate a repulsive force acting on the third comb array to move the third comb array away from the second comb array.

According to another aspect of the invention, there is provided an electrostatic actuator comprising: at least two electrostatic actuator elements, each electrostatic actuator element having: first and second comb arrays of electrodes arranged on a base, the electrodes of the first and second comb arrays being interleaved; a third comb array of electrodes spring mounted over the first and second comb arrays, the electrodes of the third comb array being aligned with the electrodes of the second comb array; and, means for applying a first voltage to the second and third comb arrays and a second voltage to the first comb array to generate a repulsive force acting on the third comb array to move the third comb array away from the second comb array; wherein the third comb array of electrodes of each electrostatic actuator element is formed on a common body.

### BRIEF DESCRIPTION OF THE DRAWINGS

Embodiments of the invention may best be understood by referring to the following description and accompanying drawings. In the description and drawings, like numerals refer to like structures or processes. In the drawings:

FIG. A is a perspective view illustrating a bi-directional electrostatic actuator having four bi-directional electrostatic actuator elements in accordance with an embodiment of the invention;

FIG. B is a first cross-sectional view of one bi-directional electrostatic actuator element of the actuator of FIG. A in accordance with an embodiment of the invention; and,

FIG. C is a second cross-sectional view of one bi-directional electrostatic actuator element of the actuator of FIG. A in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and techniques have not been described or shown in detail in order not to obscure the invention.

The present invention provides an optimized bi-directional MEMS electrostatic actuator. The actuator can generate attractive and repulsive forces to effect bi-directional relative motion between two opposing arrays of electrodes. The actuator may serve as the basic unit in the fabrication of RF MEMS devices such as tunable capacitors and optical MEMS devices such as torsion micromirrors and translation micromirrors.

In addition, the present invention provides a hybrid method which combines numerical simulation and least-square approximation to optimize the propulsive force and the displacement of the bi-directional electrostatic actuator. By using the method provided in the present invention, performance measures of the bi-directional actuator, such as the relation of the force versus the gap distance and the relation of the displacement versus the applied voltage, can be obtained. Based on the method provided in the invention, the structural parameters in the bi-directional actuator can be chosen to satisfy the requirements of different applications.

In particular, the present invention provides several rules for designing and optimizing the bi-directional actuator based on the hybrid method. These rules include the following:
Rule 1: The stroke under repulsive force in the bi-directional electrostatic actuator is mainly affected by the lateral size of the fixed electrodes, distance between moving fingers and distance between fixed electrodes;
Rule 2: The stroke under repulsive force in the bi-directional actuator can be increased by increasing the lateral size described in Rule 1; and
Rule 3: Smaller lateral size leads to larger repulsive force.

Moreover, the invention provides a derivation of the relations between the structural parameters of the bi-directional actuator of the present invention. Optimized performance of the bi-directional actuator can be achieved only when these relations are satisfied. In other words, the bi-directional actuator works best when these relations are satisfied. Specific relationships between the physical parameters of the actuator components can be obtained from the present invention by following the above rules. A detailed description of these relationships is provided in the following.

The present invention provides several advantages. For example, without this invention, the repulsive force and the stroke cannot be readily optimized. This would lead to larger components, higher driving voltages, and higher production costs. Optimizing the repulsive force and the stroke by the standard trial and error approach would lead to long product development cycles and high development costs.

FIG. A is a perspective view illustrating a bi-directional electrostatic actuator 100 preferably having four bi-directional electrostatic, actuator elements 110, 120, 130, 140 in accordance with one embodiment of the invention. FIG. B a first partial cross-sectional view of one bi-directional electrostatic actuator element 110 of the actuator 100 of FIG. A in accordance with an embodiment of the invention. FIG. C is a second partial cross-sectional view of one bi-directional electrostatic actuator element 110 of the actuator 100 of FIG. A in accordance with a particular embodiment of the invention. Thus, FIG. A shows four bi-directional actuators 110, 120, 130, 140. FIGS. B and C are partial cross-sectional views of one bi-directional actuator 110. When a voltage is applied in the form shown in FIG. C, an attractive force is generated between the moving fingers and fixed fingers. When a voltage is applied in the form of FIG. B, a repulsive force is generated.

The hybrid method of the present invention can be described as follows.

Step 1: In the bi-directional actuator 110, the finger length (which can range from tens to more than a hundred micrometers) is much larger than the finger width and therefore the electric fields in all the cross-sections along the finger length have a similar boundary. Thus, the output force of the actuator can be obtained by integrating the force per unit length along a cross section of the actuator over the finger length as shown in Eqs. (A) and (B):

f_{attract}_{_{—}}ₜₒₜₐₗ=V_{attract}²·L·f_{attract}_{_{—}}ᵤₙᵢₜ_{_{—}}_{voltage}_{_{—}}_{length} (A)

fᵣₑₚᵤₗ_{_{—}}ₜₒₜₐₗ=Vᵣₑₚᵤₗ²·L·fᵣₑₚᵤₗ_{_{—}}ᵤₙᵢₜ_{_{—}}_{voltage}_{_{—}}_{length} (B)

Where V is the driving voltage, L is the finger length, f_{attract}_{_{—}}ᵤₙᵢₜ_{_{—}}_{voltage}_{_{—}}_{length} is the attractive force per unit length along a cross-section of one actuator at a unit driving voltage of 1 volt, fᵣₑₚᵤₗ_{_{—}}ᵤₙᵢₜ_{_{—}}_{voltage}_{_{—}}_{length} is the repulsive, force per unit length along a cross-section of one actuator at a unit driving voltage of 1 volt, f_{attract}_{_{—}}ₜₒₜₐₗ is the total attractive force produced in the actuator, and fᵣₑₚᵤₗ_{_{—}}ₜₒₜₐₗ is the total repulsive force produced in the actuator.

Step 2: The force per unit length along a cross-section of an actuator is obtained by numerical simulation as a function of the gap distance.

Step 3: The method of least-square is used to approximate the numerical simulation with a polynomial as show in Eqs (C) and (D):

f_{attract}_{_{—}}ᵤₙᵢₜ_{_{—}}_{voltage}_{_{—}}_{length}=(cₐ_{_{—3}}·g³+cₐ_{_{—2}}·g²+cₐ_{_{—1}}·g+cₐ_{_{—0}}) (C)

fᵣₑₚᵤₗ_{_{—}}ᵤₙᵢₜ_{_{—}}_{voltage}_{_{—}}_{length}=(cᵣ_{₃}·g³+cᵣ_{_{—}}₂·g²+cᵣ_{_{—}}₁·g+cᵣ_{_{—0}}) (D)

The order of the polynomial can be higher or lower than 3.

Step 4: The following two equations hold in a structure driven by the bi-directional actuator:

f_{attract}_{_{—}}ₜₒₜₐₗ=K·(g₀−g) (E)

fᵣₑₚᵤₗ_{_{—}}ₜₒₜₐₗ=K·(g−g₀) (F)

Where K is the stiffness and g₀ is the initial gap distance.

Step 5: Substituting Eqs. (A) and (B) into Eqs. (E) and (F) leads to the relation of the applied voltage versus the gap distance as shown in Eqs. (G) and (H):

$$\begin{matrix}{V}_{attract} = \sqrt{\frac{K \cdot ( {g}_{0} - g )}{L \cdot {f}_{attract \_ unit \_ voltage \_ length}}} & ( G ) \\ {V}_{repulsive} = \sqrt{\frac{K \cdot ( g - {g}_{0} )}{L \cdot {f}_{repul \_ unit \_ voltage \_ length}}} & ( H )\end{matrix}$$

Step 6: The performance of the devices (e.g., 100) driven by the bi-directional actuator 110 can be derived based on Eqs. (G) and (H).

For example, the capacitance and tuning ratio of a tunable capacitor driven by the bi-directional actuator can be obtained by Eqs (G) and (H). If the device is a translation or a torsion micromirror, the vertical movement or the rotation angle versus applied voltage can be obtained by Eqs. (G) and (H).

According to the present invention, when designing a bi-directional actuator 110 (as described in U.S. patent application Ser. No. 11/249,628), the structural parameters should be chosen to satisfy the following requirements in order to achieve optimized performance. Referring to FIG. B:
1. The width of moving fingers, a, preferably is not smaller than the thickness of the moving fingers, t₁, i.e., a≧t₁;
2. The width of the aligned fixed fingers, b, preferably is not smaller than the width of the moving fingers, i.e., a≦b≦10a; and,
3. The distance between aligned fixed fingers and their neighboring unaligned fixed fingers, d, preferably follows the relationship 0.5b≦d≦4b; and,
4. The width of unaligned fixed fingers, c, should follow approximately 0.5b≦c≦5b.

As an example of the utility of the invention, the optimal design for a bi-directional actuator-based tunable capacitor with a spring constant of 5 N/m, an initial gap distance of 2 μm and tuning ratio of 5:1, should have the following structural specification:

a=6 μm

b=8 μm

c=8 μm

d=8 μm

t₁=1 μm

t₂=2 μm

It can be demonstrated that these structural parameters follow the four requirements outlined above.

As yet another example of the utility of this invention, the design of a bi-directional actuator-based rotating mechanism optimized for a 5° rotation angle with an initial gap as in the above example may be provided by following structural parameters:

a=6 μm

b=8 μm

c=6 μm

d=6 μm

t₁=0.5 μm

t₂=2 μm

It should be emphasized that these rules help specify structural parameter relationships for devices derived from the bi-directional actuator to provide optimal performance. Specifications outside these requirements will provide adequate, but not optimal performance.

Thus, the present invention provides a hybrid method of modeling a bi-directional electrostatic actuator, which combines numerical simulation and least-square approximation. By using this hybrid method, the force and displacement of the bi-directional actuator can be derived. Therefore, the performance of the devices driven by the bi-directional actuator can be obtained. Based on the hybrid method the invention provides several rules for designing and optimizing the bi-directional actuator in order to meet the requirements of different applications. These designing rules include that the stroke can be improved by increasing the lateral size of the electrodes and that the repulsive force can be increased by choosing a small lateral size. The invention provides a derivation of the relations between the structural parameters of the bi-directional actuator. The invention derives the optimized relations of structural parameters of the bi-directional actuator. These relations are as follows: (1) The width of moving fingers, a, should not be smaller than the thickness of the moving fingers, t₁, i.e., a≧t₁; (2) The width of the aligned fixed fingers, b, should not be smaller than the width of the moving fingers, i.e., a≦b≦10a; (3) The distance between aligned fixed fingers and their neighboring unaligned fixed fingers, d, should follow the relationship 0.5b≦d≦4b; and, (4) The width of unaligned fixed fingers, c, should follow approximately 0.5b≦c≦5b.

Advantageously, the present invention provides a method for optimizing the performance of a hi-directional actuator using a hybrid of numerical simulation and least-square approximation. The hybrid method can be used to optimize the performance of the bi-directional actuator, such as initial gap distance, driving voltage, electrode size, and spatial relationship, to achieve required specifications such as a large stroke or a large force. The hybrid method can be used to design high tuning ratio tunable capacitors based on bi-directional actuators. The hybrid method can be used to design large rotation micromirror actuators based on bi-directional actuators. And, the invention provides a bi-directional actuator 110 with the following relationship between structural parameters and spatial arrangement: (1) The width of moving fingers, a, should not be smaller than the thickness of the moving fingers, t₁, i.e., a≧t₁; (2) The width of the aligned fixed fingers, b, should not be smaller than the width of the moving fingers, i.e., a≦b≦10a; (3) The distance between aligned fixed fingers and their neighboring unaligned fixed fingers, d, should follow the relationship 0.5b≦d≦4b; and, (4) The width of unaligned fixed fingers, c, should follow approximately 0.5b≦c≦5b.

Although preferred embodiments of the invention have been described herein, it will be understood by those skilled in the art that variations may be made thereto without departing from the spirit of the invention or the scope of the appended claims.

What is claimed is:

1. An electrostatic actuator having (a) a base containing a plurality of electrodes; (b) a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and (c) a means for applying voltage to the electrostatic actuator, said means being operable to generate one, or both at different intervals, of:
(i) a repulsive electrostatic force by applying a voltage of V1 to the electrodes on the movable element, V1 to the aligned electrodes on the base and V2 to the non-aligned electrodes on the base; or
(ii) an attractive electrostatic force by applying a voltage of V1 to the electrodes on the moveable element, and V2 to the aligned and non-aligned electrodes on the base;
characterized in that the electrodes of the moveable element each have a thickness t₁ and a width a such that a≧t₁; and the width of the corresponding aligned electrode(s), b, is preferably not smaller than the width of the electrodes of the moveable element, a such that a≦b≦10a.

2. The electrostatic actuator of claim 1, characterized in that the aligned and non-aligned electrodes of the base are separated by a distance d such that 0.5b≦d≦4b.

3. The electrostatic actuator of claim 1 or 2, characterized in that the width of the non-aligned electrodes is sized such that 0.5b≦c≦5b.

4. The electrostatic actuator of claim 1, wherein the base includes a first and second comb array of electrodes arranged on the base, the electrodes of the first and second comb array being interleaved; and the moveable element includes a third comb array of electrodes is spring mounted over the first and second comb arrays, the electrodes of the third comb array being aligned with the electrodes of the second comb array; the electrodes of the movable element define a third comb array,
characterized in that first and second comb arrays are coplanar.

5. The electrostatic actuator of claim 1, characterized in that the third comb array is at least one of translatable and rotatable with respect to the first and second comb arrays.

6. An electrostatic actuator characterized in that it includes:
(a) at least two electrostatic actuator elements, each electrostatic actuator element having:
(i) a base containing a plurality of electrodes;
(ii) a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and
(iii) a means for applying voltage to the electrostatic actuator, said means being operable to generate one, or both at different intervals, of:
(A) a repulsive electrostatic force by applying a voltage of V1 to the electrodes on the movable element, V1 to the aligned electrodes on the base and V2 to the non-aligned electrodes on the base; or
(B) an attractive electrostatic force by applying a voltage of V1 to the electrodes on the moveable element, and V2 to the aligned and non-aligned electrodes on the base; and
(b) wherein the moveable element of the at least two electrostatic actuator elements is formed on a common body.

7. The electrostatic actuator of claim 6, characterized in that the electrodes of the moveable element each have a thickness t₁ and a width a such that a≧t₁; and
the width of the corresponding aligned electrode(s), b, is preferably not smaller than the width of the electrodes of the moveable element, a such that a≦b≦10a.

8. The electrostatic actuator of claim 6, characterized in that the aligned and non-aligned electrodes of the base are separated by a distance d such that 0.5b≦d≦4b.

9. The electrostatic actuator of claim 6 or 7, characterized in that the width of the non-aligned electrodes is sized such that 0.5b≦c≦5b.

10. A method of modeling a design for an electrostatic actuator (a) a base containing a plurality of electrodes; (b) a movable element being movably connected to the base, the moveable element including a plurality of electrodes, one or more of the plurality of electrodes having a corresponding, aligned electrode on the base, and each aligned electrode on the base being disposed adjacent to at least one non-aligned electrode disposed on the base; and (c) a means for applying voltage to the electrostatic actuator, said means being operable to generate one, or both at different intervals, of:
(i) a repulsive electrostatic force by applying a voltage of V1 to the electrodes on the movable element, V1 to the aligned electrodes on the base and V2 to the non-aligned electrodes on the base; or
(ii) an attractive electrostatic force by applying a voltage of V1 to the electrodes on the moveable element, and V2 to the aligned and non-aligned electrodes on the base;
characterized by combining a numerical simulation and a least-square approximation to obtain the force and displacement of the moveable element.

11. The method of claim 10, further characterized by obtaining the output force for the electrostatic actuator by integrating a force per unit length along a cross section of the actuator over a length of the electrodes.

12. The method of claim 11, further characterized by obtaining the force per unit length by a numerical simulation as a function of the distance between the base and moveable element in a resting position.

13. The method of claim 12, further characterized by obtaining the numerical simulation by operation of a least-square method.

14. The method of claim 11, further characterized by establishing the relationship between the output force for the first part, and the stiffness of the electrodes and the distance between the base and moveable element in a resting position, for the second part.

15. The method of claim 14, further characterized by substituting the output force into the relationship established between the output force, for the first part, and stiffness of the electrodes and the distance between the base and the moveable element in the resting position, for the second part, so to establish the relationship of applied voltage versus the distance between the base and the moveable element.

16. The method of claim 15, further characterized by deriving the design for the electrostatic actuator based on desired performance characteristics.
